(19) United States
(12) Patent Application Publication
(10) Pub. No.: US 2008/0091827 A1
(43) Pub. Date: Apr. 17, 2008

(54) METHOD, DEVICE AND SYSTEM FOR ALLOCATING MEDIA RESOURCES

(76) Inventors: Xiaojun MO, Shenzhen (CN); Yu SU, Shenzhen (CN); Yanyu WU, Shenzhen (CN); Lin LIN, Shenzhen (CN); Tao SONG, Shenzhen (CN); Gaofeng YANG, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/955,652

(22) Filed: Dec. 13, 2007

Related U.S. Application Data
(63) Continuation of application No. PCT/CN2007/070159, filed on Jun. 22, 2007.

(30) Foreign Application Priority Data
Jul. 29, 2006 (CN) 200610061880.9

(51) Int. Cl. G06F 15/173

(52) U.S. Cl. 709/226

(57) ABSTRACT

A method of allocating media resources includes: receiving a media resource request from a media resource requesting entity; selecting a media resource processing device capable of fulfilling the requirement according to previously acquired media resource capability information of media resource processing devices, to perform the service operation relating a media resource. A device and a system for allocating media resources are also described. According to these solutions, reasonable resource allocation and balanced loads on resources are achieved by acquiring necessary information.

### CROSS-REFERENCES TO RELATED APPLICATIONS

The present application is a continuation of PCT Application No. PCT/CN2007/070159, filed on Jun. 22, 2007, which claims the benefit from Chinese Patent Application CN200610061880.9, filed in the China Patent Office on Jul. 29, 2006, the entire contents of which are incorporated herein by reference.

### FIELD OF THE INVENTION

The present invention relates to the field of communications, and in particular, to a method, a device and a system for allocating media resources.

### BACKGROUND OF THE INVENTION

With development of the communication technology, the requirement for media resource components is increasing. For example, in the third generation communication system (3G) networking, the media resource function (MRF) is divided into the media resource function control (MRFC) and the media resource function process (MRFP). The MRFC is responsible for control of and access to the media resources, whereas the MRFP is responsible for processing of the media resources. The MRFC controls the MRFP to process the media resources, and both the MRFC and the MRFP collaborate to export the MRF. One MRFC may manage and control a plurality of MRFPs to export the media resources. When one MRFC controls a plurality of MRFPs, it is difficult to select one or more of the MRFPs by the MRFC. Upon receiving a request for a media resource, the MRFC selects an MRFP for processing the requested media resource. However, the MRFC may not have sufficient knowledge about resource occupation status on the MRFP, and accordingly, the MRFC may possibly select an MRFP with no resource available. In this situation, a failure may occur in the resource processing. Moreover, if the MRFC selects an MRFP in a random manner, there may be unbalanced loads from one MRFP to another, thus making the system unstable.

The above difficulty has been overcome through a prior-art approach. According to this approach, the MRFC specifies an MRFP to operate a media resource. The MRFP will return an error indication informing of insufficient resources if the MRFP has no sufficient media resource, and in this situation, the MRFC controls to select another MRFP to provide the required media resource, or releases the call directly and notifies of a failure. For a subsequent time period, the MRFP is made to stop operating.

During making the invention, the inventors find that this approach has at least the following disadvantages: 1) an MRFP is selected by the MRFC randomly, and the probability that an error occurs during the procedure increases because of the random MRFC selection; 2) the unbalanced loads from one MRFP to another remains unresolved; 3) it is difficult to determine the length of a time period during which it is paused to dispatch media resource operations to an MRFP suffering from an error due to overload.

### SUMMARY OF THE INVENTION

In one aspect, an embodiment of the present invention provides a method of allocating media resources to achieve reasonable resource allocation and balanced loads on resources.

In another aspect, an embodiment of the present invention also provides a device and a system for allocating media resources to reduce the probability of failure in processing the media resource allocation and to achieve balanced loads on the MRFPs.

An embodiment of the present invention provides a method of allocating media resources, including:

receiving a media resource request from a media resource requesting entity;

selecting a media resource processing device capable of fulfilling the requirement according to previously acquired media resource capability information of media resource processing devices, to perform the service operation relating a media resource.

An embodiment of the present invention provides a system for allocating media resources, including a media resource control device and one or more media resource processing devices, wherein,

the media resource processing device is adapted to perform the media resource service;

the media resource control devices is adapted to receive a media resource request from a media resource requesting entity, and select a media resource processing device capable of fulfilling the requirement according to previously acquired media resource capability information of the media resource processing devices, to perform the media resource service.

An embodiment of the present invention provides a media resource allocation controlling device, includes:

a media resource request interface module adapted for interacting with a media resource requesting entity via messages, including receiving a media resource request from the media resource requesting entity;

a media resource control interface module adapted for interacting with media resource processing devices via messages;

a media resource capability management module adapted for recording and managing media resource capability information of the media resource processing devices;

a selection module adapted for selecting a media resource processing device capable of fulfilling the requirement according to the media resource capability information of the media resource processing devices, to perform the media resource service, and notifying the media resource processing device through the media resource control interface module.

An embodiment of the present invention provides a media resource allocation processing device for perform the media resource service, including:

a media resource processing interface module adapted for interacting with a media resource control device via messages, including receiving a notification of performing the media resource service sent by the media resource control device;

a media resource allocating module adapted for performing media resource allocation according to the notification, and for sending the allocation result to the media resource control device through the media resource processing interface module;

a capability information reporting module adapted for reporting the media resource capability information to the media resource control device.

The embodiments of the present invention achieve resource information synchronization through reporting and acquiring the resource information, thereby realizing reasonable resource allocation, increasing quality of resource services, and increasing the rate of successful responses to request operations. In a network having a plurality of MRFPs, balanced loads on the MRFPs can also be achieved.

### BRIEF DESCRIPTION OF THE DRAWINGS

FIG. 1 is a flow chart showing a method according to a first embodiment of the invention;

FIG. 2 is a flow chart showing a method according to a second embodiment of the invention;

FIG. 3 is a flow chart showing a method according to a third embodiment of the invention;

FIG. 4 is a flow chart showing a method according to a fourth embodiment of the invention;

FIG. 5 is a structural diagram showing a system according to an embodiment of the invention;

FIG. 6 is a structural diagram showing a media resource control device according to an embodiment of the invention; and

FIG. 7 is a structural diagram showing a media resource processing device according to an embodiment of the invention.

### DETAILED DESCRIPTION OF THE EMBODIMENTS

The embodiments of the invention will now be further illustrated in detail in conjunction with the drawings.

A requesting entity for the media resource function may be a broadband terminal in the next generation network (NGN), and an application server (AS) in the 3G network. In the NGN network, the media resource controlling device is referred to as a Media Gateway Controller (MGC), and the media resource processing device is referred to as a Media Resource Server (MRS). In the 3G network, the media resource controlling device is referred to as an MRFC, and the media resource processing device is referred to as an MRFP. The process of the method according to an embodiment of the invention is described as follows:

A. A requesting entity for the media resource function sends a message to a media resource controlling device via a signaling interface or a messaging interface for requesting a media resource service;

B. The media resource controlling device performs an analysis according to information about capabilities supported by media resources and information about idle status of the media resources on media resource processing devices, and selects a media resource processing device fulfilling the requirement to perform the service operations for media resource requests.

The media resource processing device may, under control of the media resource control device, perform the media resource processing according to the media resource request dispatched by the media resource control device; and the media resource processing device may interact with media resource requesting devices to transmit media resource data.

There may also be such a case that requesting entities for the media resource function MRF do not request respective media resource services, and instead, operators or other providers initiatively provide their media resource services to the media resource requesting entities, for their own demands.

An identification indicating the type of a media resource operation to be performed is usually carried in the media resource request, for example an identification indicating a media resource operation of playback. From this carried information, the media resource control device knows that the playback capability is requested by the media resource request. For another example, if an identification indicating a media resource operation of recording is carried, the media resource control device therefore knows that the recording capability is requested by the media resource request. In response to receiving a media resource request, the media resource controlling device performs analysis and classification on the requested resources by their capabilities, and selects a media resource processing device that can meets the requirements. The classification on the media resources by their capabilities may be performed according to requirements for products, and the products may have different capability classes depending on the difference between their implementations. For example, if the playback and recording capabilities are realized at the same time in a product, the playback and recording capabilities may be integrated as one capability. Otherwise, they may be regarded as two different capabilities. The capability information about media resources usually includes idle status information, resource occupation information, general resource information or classification information for the media resource processing devices.

By taking control relation between MRFC and MRFP components in the 3G network as example, the process of the method will now be described as follows.

To avoid the case where an MRFC selects MRFPs blindly, the MRFC acquires capability information about media resources of the MRFPs, including media resource occupation information. With respect to the capability information about the media resources, the MRFC may synchronize with the MRFPs through the following methods:

Method 1: The MRFPs initiatively report to the MRFC periodically; Method 2: The MRFC initiatively acquires the resource information as needed or periodically, i.e. sending a message to the MRFPs to acquire information about the media resources occupied by the MRFPs. The reported content includes information about various idle media resources. The reported content may take various forms, such as including resource occupancy and general resource information, and including general resource information and information about occupied resources. For the current standard SIP, H.248 and MGCP protocols, it is possible to employ an approach in which the MRFPs periodically report the media resource occupancy; or an approach in which the MRFC periodically dispatches audit and request operations, so that the MRFPs report the media resource occupation status via audit and request responses. It is also possible to extend the internal private protocol between the MRFC and the MRFPs. The MRFC computes remaining resource capabilities of the MRFPs from the information reported by the MRFPs or the information acquired by the MRFC initiatively from the MRFPs, so as to perform an analysis to select the MRFP for providing the service. In this embodiment, the resource information is synchronized between the MRFC and the MRFPs, thereby achieving benefits of reasonable resource allocation, increased rate of successful resource responses to request operations, and improved quality of services exported by resources.

Upon acquiring the capability information of the MRFPs' media resources, the MRFC saves the information, and analyzes, upon receiving a media resource request, the requested resource capability to select an appropriate MRFP and update the saved resource occupation information of the MRFPs. If it is determined that there is only one of the MRFPs that can provide the requested resource capability, this MRFP should be the only choice to avoid selecting other MRFPs, which may otherwise cause failure in the resource processing. If it is determined that there are a plurality of MRFPs that can provide the requested resource capability, the MRFP that is the idlest or nearest to the location of the resource requester may be selected, or an appropriate MRFP may be selected according to other criteria. For example, if the MRFC finds that a certain MRFP is busy, i.e. its resource occupancy rate is high; it is preferential to select other MRFPs, so as to realize flow control for the busy MRFP, and balanced loads on the MRFPs.

This will now be further illustrated in conjunction with flow charts.

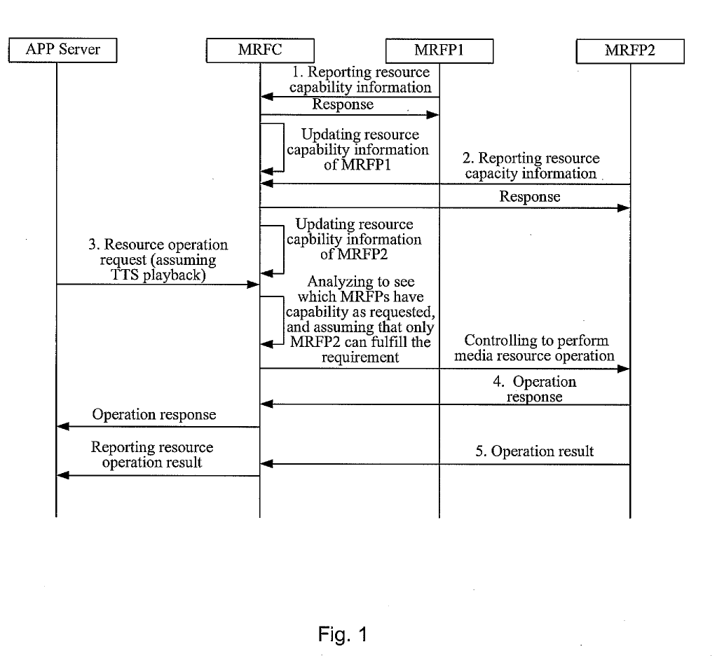

As shown in FIG. 1, the MRFPs report their resource capability status to the MRFC regularly, and the MRFC controls to achieve balanced loads on the MRFPs. More specifically, the process is exemplified as follows:

1. The MRFP 1 reports its resource capability information to the MRFC. The MRFC updates its saved resource capability information relating to the MRFP 1.

2. The MRFP 2 reports its resource capability information to the MRFC. The MRFC updates its saved resource capability information relating to the MRFP 2.

3. The MRFC receives a resource operation request from a resource requesting entity (such as an AS Server), for example for requesting to perform TTS (text to speech) playback. The MRFC analyzes the resource capability being required, and searches for the MRFPs capable of fulfilling the resource capability requirement according to the resource capability being required. If there is only one MRFP capable of fulfilling the capability requirement, the resource request will be sent to this MRFP for processing (MRFP 2 in the Figure). In this way, it is possible to avoid the case where the MRFC dispatches the resource request randomly to an MRFP that does not support such a resource operation, resulting in a failure in the resource operation.

4.-5. Upon receiving the resource operation request, the MRFP2 processes the resource operation request and reports a resource operation response and a result. The MRFC reports the information to the resource requesting entity (the AS in this case).

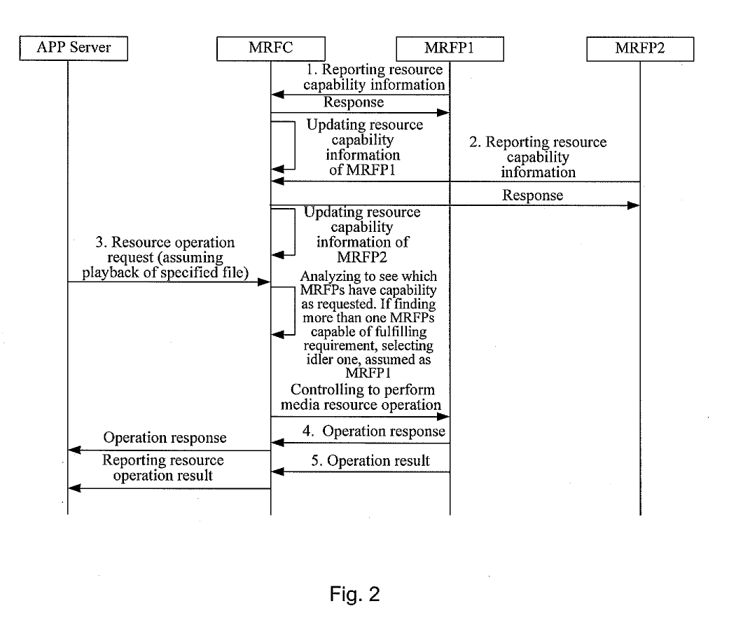

As shown in FIG. 2, the MRFPs report their resource capability status to the MRFC regularly. The MRFC controls to achieve balanced loads on the MRFPs. The process is exemplified as follows:

1. The MRFP 1 reports its resource capability information to the MRFC. The MRFC updates its saved resource capability information relating to the MRFP 1.

2. The MRFP 2 reports its resource capability information to the MRFC. The MRFC updates its saved resource capability information relating to the MRFP 2.

3. The MRFC receives a resource operation request (for example, for playback of a specified file) from a resource requesting entity (such as an AS). The MRFC analyzes the resource capability being required, and searches for the MRFPs capable of fulfilling the resource capability requirement according to the resource capability being required. If there is a plurality of MRFPs capable of fulfilling the capability requirement, the idlest one of these MRFPs (MRFP 1, as shown in the FIG. 2) is selected to process the resource capability request. In this way, it is possible to avoid the case where the MRFC dispatches the resource capability request randomly, resulting in unbalanced loads on resources of the MRFPs.

4.-5. Upon receiving the resource operation request, the MRFP 1 processes the resource operation request, and reports a resource operation response and a result. The MRFC reports the information to the resource requesting entity (the AS in this case).

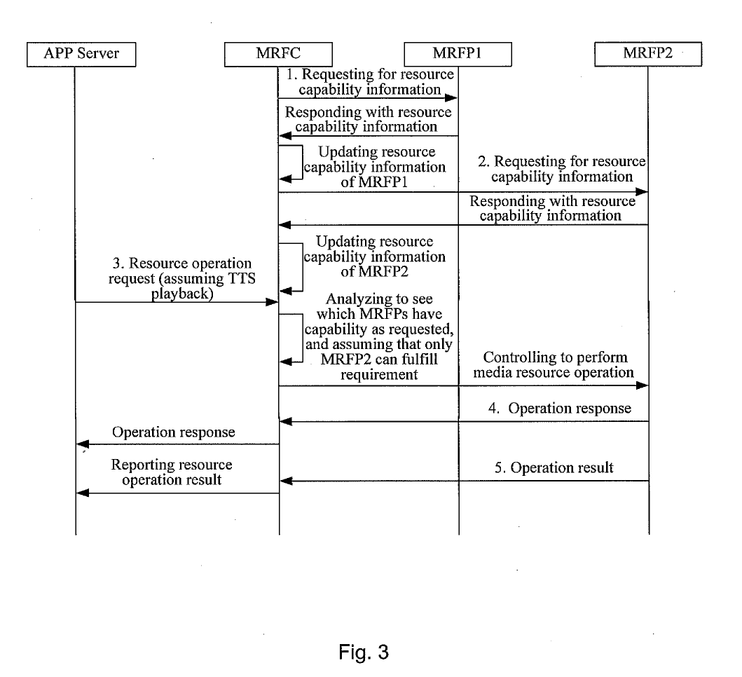

As shown in FIG. 3, the MRFC initiatively acquires the resource information periodically or as needed by sending a message to the MRFPs to acquire the media resource occupation information. The process is exemplified as follows:

1. The MRFC initiatively requests the resource capability information from the MRFP 1. The MRFP1 responds to send its resource capability information to the MRFC. The MRFC updates its saved resource capability information relating to the MRFP 1.

2. The MRFC initiatively requests the resource capability information from the MRFP 2. The MRFP2 responds to send its resource capability information to the MRFC. The MRFC updates its saved resource capability information relating to the MRFP 2.

3. The MRFC receives a resource operation request from a resource requesting entity (such as an AS), for example for requesting to perform TTS (text to speech) playback. The MRFC analyzes the resource capability be required, and searches for the MRFPs capable of fulfilling the resource capability requirement according to the resource capability being required. If there is only one MRFP capable of fulfilling the capability requirement, the resource request will be sent to this MRFP for processing (MRFP 2 in the Figure). In this way, it is possible to avoid the case where the MRFC dispatches the resource request randomly to an MRFP that does not support such a resource operation, resulting in a failure in the resource operation.

4.-5. Upon receiving the resource operation request, the MRFP 2 processes the resource operation request and reports a resource operation response and a result. The MRFC reports the information to the resource requesting entity (the AS in this case).

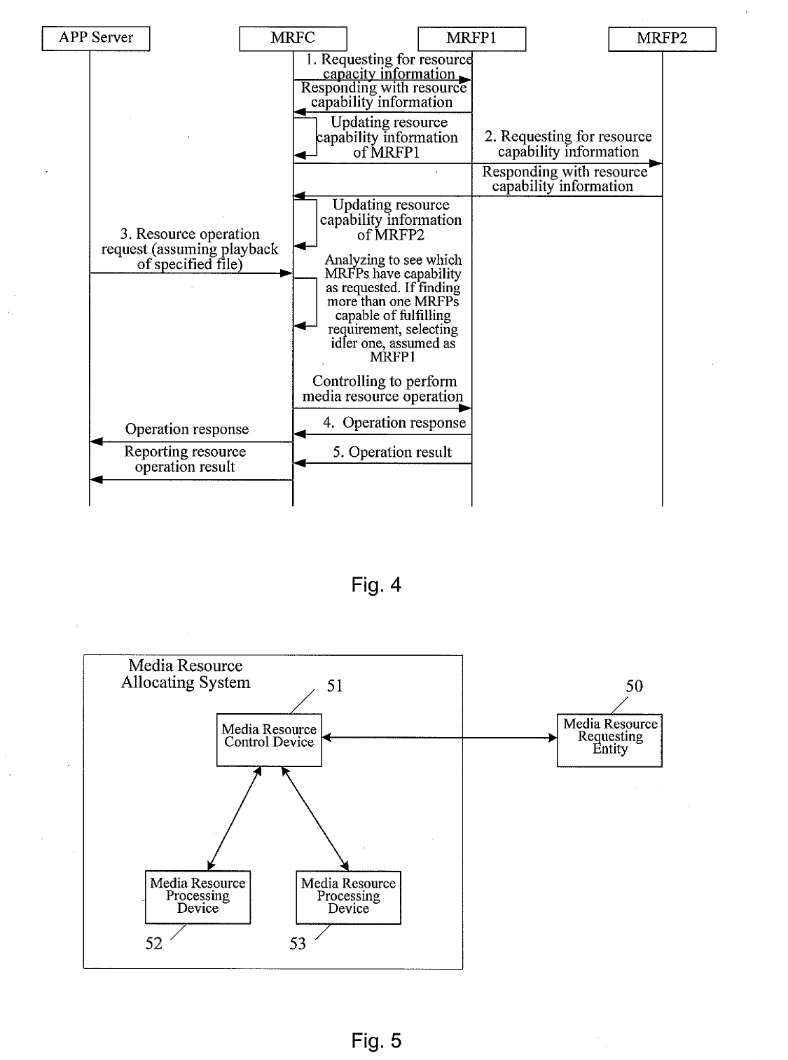

As shown in FIG. 4, the MRFC initiatively acquires the resource information periodically or as needed by sending a message to the MRFPs to acquire the media resource occupation information, and controls to achieve balanced loads on the MRFPs. The process is exemplified as follows:

1. The MRFC initiatively requests the resource capability information from the MRFP 1. The MRFP 1 responds to send its resource capability information to the MRFC. The MRFC updates its saved resource capability information relating to the MRFP 1.

2. The MRFC initiatively requests the resource capability information from the MRFP 2. The MRFP2 responds to send its resource capability information to the MRFC. The MRFC updates its saved resource capability information relating to the MRFP2.

3. The MRFC receives a resource operation request (for example for playback of a specified file) from a resource requesting entity (such as an AS). The MRFC analyzes the resource capability being required, and searches for the MRFPs capable of fulfilling the resource capability requirement according to the resource capability being required. If there is a plurality of MRFPs capable of fulfilling the capability requirement, the idlest one of these MRFPs (MRFP1, as shown in the FIG. 2) is selected to process the resource capability request. In this way, it is possible to avoid the case where the MRFC dispatches the resource capability request randomly, resulting in unbalanced loads on resources of the MRFPs.

4.-5. Upon receiving the resource operation request, the MRFP 1 processes the resource operation request and reports a resource operation response and a result. The MRFC reports the information to the resource requesting entity (the AS in this case).

The structure of a system for allocating media resources according to an embodiment of the invention is shown in FIG. 5.

The system includes a media resource controlling device 51 and media resource processing devices 52 and 53. The media resource processing devices 52 and 53 are adapted to perform the service operations relating to media resources. The media resource controlling device 51 is adapted to receive a media resource request form a media resource requesting entity 50, and to select, according to media resource capability information of the media resource processing devices, one of the media resource processing devices capable of fulfilling the requirement to perform the media resource service. The media resource controlling device 51 controls to select the media resource processing device to export resources.

The media resource processing devices 52 and 53 interact with the media resource requesting entity 50 to transfer data via media resource data stream channels.

The media resource controlling device 51 is further adapted to send a message to the media resource processing devices 52 and 53 so as to acquire media resource capability information. Alternatively, the media resource processing devices 52 and 53 may periodically report the media resource capability information to the media resource controlling device 51. Upon acquiring the media resource capability information, the media resource controlling device 51 updates its saved media resource capability information relating to the media resource processing devices 52 and 53.

The media resource controlling device 51 and the media resource processing devices 52 and 53 are connected by extending standard SIP, H.248 or MGCP protocol or an internal private protocol.

The process of medial resource allocation in the system according to the present embodiment is similar to the method according to the embodiment of the invention as described in the above, and will not be described in detail hereafter.

An embodiment of the invention also provides a media resource allocation controlling device. The device is adapted to receive a resource request form a media resource requesting entity, and to select a media resource processing device to perform the media resource service, according to media resource capability information of media resource processing devices. The device is further adapted to receive requests from external media resource requesting entities and control the media resource processing devices to export resources. The device is further adapted to send a message to the media resource processing devices to acquire the media resource capability information, or alternatively, to receive the media resource capability information reported regularly by the media resource processing devices. The device is further adapted to, upon receiving the media resource capability information, update its saved media resource capability information relating to the media resource processing devices and save the updated media resource capability information relating to the media resource processing devices.

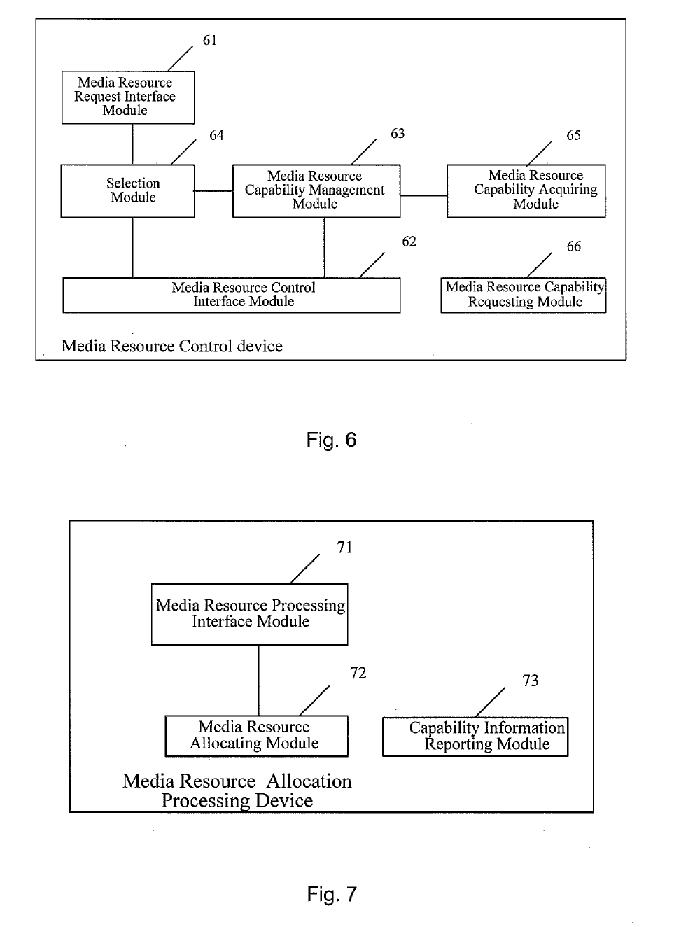

A reference will be made to the structure of a media resource allocation controlling device according to an embodiment as shown in FIG. 6.

The device includes a media resource request interface module 61, a media resource capability management module 63, a media resource control interface module 62 and a selection module 64. The media resource request interface module 61 interacts via messages with the media resource requesting entity (not shown), including receiving a media resource request from the media resource requesting entity. The media resource control interface module 62 interacts via messages with the media resource processing devices (not shown). The media resource capability management module 63 is adapted to record and manage the media resource capability information of the media resource processing devices. The selection module 64 is adapted to select, according to the media resource capability information of the media resource processing devices, a media resource processing device capable of fulfilling the requirement to perform the media resource service, and to notify the media resource processing device via the media resource control interface module 62.

The media resource capability management module 63 may be configured with initial media resource capability information relating to all the media resource processing devices in the network. In this way, in response to the media resource control interface module 62 receiving result information about the media resource service performed by a certain media resource processing device, the media resource capability management module 63 updates media resource capability information relating to the media resource processing device, to ensure that its recorded media resource capability information relating to a media resource processing device corresponds to present capabilities of the media resource processing device. Therefore, the selection module 64 can select a media resource processing device capable of fulfilling the requirement according to the present capabilities of media resource processing devices to ensure the load balance of various media resource processing devices in applications of multi-media resource processing devices.

The device may also dynamically acquire the media resource capability information of the media resource processing devices. Referring to FIG. 6, the device may also be provided with a media resource capability acquiring module 65 for receiving the media resource capability information reported by the media resource processing devices, and for notifying the media resource capability management module 63 to update the media resource capability information. For example, the media resource processing devices in the network send their media resource capability information regularly to the media resource allocation controlling device, so that the media resource allocation controlling device may timely acquire the current media resource capability information of the media resource processing devices.

Further, the device may also dynamically acquire the media resource capability information of the media resource processing devices by initiatively sending a request to the media resource processing devices. Referring to FIG. 6, the device may also be provided with a media resource capability requesting module 66 for initiatively sending a media resource capability request message to the media resource processing devices. In response to receiving the request message, the media resource processing devices reported their media resource capability information to the media resource control device, the media resource capability acquiring module 65 receives the media resource capability information reported by the media resource processing devices, and notifies the media resource capability management module 63 to update the media resource capability information.

An embodiment of the present invention also provides a media resource allocation processing device for providing support for media resource capabilities. The media resource allocation processing device is selected by a media resource control device to perform the media resource service request. The device may regularly report its media resource capability information to the media resource control device. Alternatively, the device may respond to an operation request from the media resource control device under control of the media resource control device.

Reference will be made to the structure of a media resource allocation controlling device according to an embodiment as shown in FIG. 7.

The device includes: media resource processing interface module 71, media resource allocating module 72 and capability information reporting module 73. The media resource processing interface module 71 is adapted to interact via messages with a media resource control device (not shown), including receiving a notification of performing the media resource service sent by the media resource control device. The media resource allocating module 72 is adapted to perform media resource allocation according to the notification, and to send the allocation result to the media resource control device through the media resource processing interface module 71. The capability information reporting module 73 is adapted to report the media resource capability information to the media resource control device. For example, it is possible for the capability information reporting module 73 to regularly and initiatively report the current media resource capability information of the device to the media resource control device. It is also possible to notify the capability information reporting module 73 to initiatively report the current media resource capability information of the device to the media resource control device, in response to the media resource allocating module 72 completing the media resource allocation. Further, it is also possible to report the media resource capability information of the device to the media resource control device in response to a request from the media resource control device. That is to say, the process where the media resource processing interface module 71 transmits messages with the media resource control device further includes: the media resource processing interface module 71 receiving the media resource capability request message sent by the media resource control device, and then the capability information reporting module 73 reporting the media resource capability information to the media resource control device in response to the request message.

From the above solutions, it should be understood that in a network-based application environment including a plurality of media resource processing devices, the system and device according to the embodiments of the present invention allocate the media resource processing devices for respective media resources to media resource requesting entities according to media resource capabilities of the media resource processing devices, so as to achieve reasonably balanced processing. Moreover, in a network-based application environment including a single media resource processing device, the embodiments of the present invention may also avoid useless resource operation dispatching. In other words, if the media resource control device already knows that there is no available resource on the media resource processing device, the subsequent arriving operation requests may be directly rejected and responded with a failure, thereby increasing the media resource allocation efficiency. For different networks, the name or components of the device may be different. For example, in a 3G network, the media resource processing function may be divided into a media resource control component MRFC, and media resource processing components MRFPs, whereas the media resource requesting entity may be an AS. The MRFC may directly controls the MRFPs to perform media resource operations, and other media resource requesting components may interact with the MRFC. For example, in an NGN network, a media resource processing function may be provided by a separate entity, for example an MRS. The media resource control component may control respective MRSs to perform media resource operations. In this case, the media resource control component may be an MGC, and a media resource processing components may be an MRS. The media resource requesting entity may be a broadband terminal. The method of the invention may be employed in both networking modes. In the NGN, the method may be implemented by extending part of the interfaces. The MGC may send a message to the MRSs through the above method. The MRSs may report their media resource capability information to the MGC, so that the MGC can reasonably selects an MRS for playback, thus avoiding errors such as resource processing failure.

Additional advantages and modifications will readily occur to those skilled in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

1. A method of allocating media resource, comprising:
receiving a media resource request from a media resource requesting entity; and
selecting a media resource processing device capable of fulfilling the requirement according to media resource capability information of media resource processing devices, to perform media resource service.

2. The method of allocating media resources according to claim 1, wherein,
the media resource capability information of the media resource processing devices is acquired through regular reports from the media resource processing devices.

3. The method of allocating media resources according to claim 1, wherein,
the media resource capability information is acquired through initiatively sending a message to the media resource processing devices.

4. The method of allocating media resources according to claim 2, further comprising:
updating saved media resource capability information of the media resource processing devices in response to the media resource capability information acquired from the media resource processing devices.

5. The method of allocating media resources according to claim 3, further comprising:
updating the saved media resource capability information of the media resource processing devices in response to the media resource capability information acquired from the media resource processing devices.

6. The method of allocating media resources according to claim 1, wherein the selecting the media resource processing device to perform the media resource service comprising:
searching for the media resource processing device capable of fulfilling the requirement according to the media resource service requested by the media resource requesting entity;
if there is only one media resource processing device capable of fulfilling the requirement, sending the request to the media resource processing device for processing;
if there is a plurality of media resource processing devices capable of fulfilling the requirement, sending the request to the media resource processing device which is the idlest or nearest to the resource service requestor for processing.

7. The method of allocating media resources according to claim 2, wherein the selecting a media resource processing device to perform the media resource service comprising:
searching for the media resource processing device capable of fulfilling the requirement according to the media resource service requested by the media resource requesting entity;
if there is only one media resource processing device capable of fulfilling the requirement, sending the request to the media resource processing device for processing;
if there is a plurality of media resource processing devices capable of fulfilling the requirement, sending the request to the media resource processing device which is the idlest or nearest to the resource service requestor for processing.

8. The method of allocating media resources according to claim 3, wherein the selecting a media resource processing device to perform the media resource service comprising:
searching for the media resource processing device capable of fulfilling the requirement according to the media resource service requested by the media resource requesting entity;
if there is only one media resource processing device capable of fulfilling the requirement, sending the request to the media resource processing device for processing;
if there is a plurality of media resource processing devices capable of fulfilling the requirement, sending the request to the media resource processing device which is the idlest or nearest to the resource service requestor for processing.

9. The method of allocating media resources according to claim 6, further comprising:
updating resource occupation information of the media resource processing device having received the request.

10. The method of allocating media resources according to claim 7, further comprising:
updating resource occupation information of the media resource processing device having received the request.

11. The method of allocating media resources according to claim 8, further comprising:
updating resource occupation information of the media resource processing device having received the request.

12. The method of allocating media resources according to claim 1, further comprising:
if there is no media resource processing device capable of fulfilling the requirement, responding to the media resource requesting entity with a failure message.

13. The method of allocating media resources according to claim 2, further comprising:
if there is no media resource processing device capable of fulfilling the requirement, responding to the media resource requesting entity with a failure message.

14. The method of allocating media resources according to claim 3, further comprising:
if there is no media resource processing device capable of fulfilling the requirement, responding to the media resource requesting entity with a failure message.

15. The method of allocating media resources according to claim 1, wherein the media resource capability information includes: idle resources information, resource occupation information, general resource information, or classification information of the media resource processing devices.

16. A system for allocating media resources, comprising a media resource control device and one or more media resource processing devices, wherein,
the media resource processing device is adapted to perform media resource service;
the media resource control devices are adapted to receive a media resource request from a media resource requesting entity, and select a media resource processing device capable of fulfilling the requirement according to media resource capability information of the media resource processing devices, to perform the media resource service.

17. The system for allocating media resources according to claim 16, wherein the media resource control device is further adapted to send a message to the media resource processing device to acquire media resource capability information.

18. The system for allocating media resources according to claim 16, wherein the media resource processing devices are adapted to regularly report the media resource capability information to the media resource control device.

19. The system for allocating media resources according to claim 16, wherein the media resource control device interacts via messages with the media resource processing devices by extended standard SIP protocol, H.248 protocol or MGCP protocol or internal private protocol.

20. The system for allocating media resources according to claim 17, wherein the media resource control device interacts via messages with the media resource processing devices by extended standard SIP protocol, H.248 protocol or MGCP protocol or internal private protocol.

21. The system for allocating media resources according to claim 18, wherein the media resource control device interacts via messages with the media resource processing devices by extended standard SIP protocol, H.248 protocol or MGCP protocol or internal private protocol.

22. A media resource allocation controlling device, comprising:
a media resource request interface module for interacting with a media resource requesting entity via messages, including receiving a media resource request from the media resource requesting entity; and
a media resource control interface module for interacting with media resource processing devices via messages;
wherein the device further comprises:
a media resource capability management module adapted for managing media resource capability information of the media resource processing devices; and
a selection module adapted for selecting a media resource processing device capable of fulfilling the requirement according to the media resource capability information of the media resource processing devices, to perform the media resource service, and notifying the media resource processing device through the media resource control interface module.

23. The media resource allocation controlling device according to claim 22, further comprising:
a media resource capability acquiring module adapted for receiving the media resource capability information reported by the media resource processing devices, and notifying the media resource capability management module to update the media resource capability information.

24. The media resource allocation controlling device according to claim 23, further comprising:
a media resource capability requesting module adapted for initiatively sending a media resource capability request message to the media resource processing devices.
